(19) United States
(12) Patent Application Publication
(10) Pub. No.: US 2019/0304458 A1
(43) Pub. Date: Oct. 3, 2019

(54) METHOD FOR CONFIGURING WIRELESS SOUND BOX, WIRELESS SOUND BOX, AND TERMINAL DEVICE

(71) Applicant: SHENZHEN GRANDSUN ELECTRONIC CO., LTD., Shenzhen (CN)

(72) Inventors: Xin CHI, Shenzhen (CN); Haiquan WU, Shenzhen (CN); Enqin ZHANG, Shenzhen (CN); Lei CAO, Shenzhen (CN); Ruiwen SHI, Shenzhen (CN)

(73) Assignee: SHENZHEN GRANDSUN ELECTRONIC CO., LTD., Shenzhen (CN)

(21) Appl. No.: 16/366,734

(22) Filed: Mar. 27, 2019

(30) Foreign Application Priority Data
Mar. 28, 2018 (CN) 201810264884.X

(51) Int. Cl. G10L 15/22; H04W 76/14

(52) U.S. Cl. CPC G10L 15/22; G10L 2015/223; H04W 76/14

(57) ABSTRACT

A method for configuring a wireless sound box includes acquiring information of a wakeup mode of a wireless sound box, where the wakeup mode comprises: a speech wakeup mode and a non-speech wakeup mode; and configuring an equalizer parameter of the wireless sound box according to the information of the wakeup mode, where said configuring an equalizer parameter of the wireless sound box according to the information of the wakeup mode comprises: configuring, under the speech wakeup mode, the equalizer parameter to be a first mode parameter for regulating a nonlinear distortion, and configuring, under the non-speech wakeup mode, the equalizer parameter into a second mode parameter for regulating an output sound effect. The accuracy of speech recognition is improved while improving the sound quality of the wireless sound box, thereby being adapted to the needs of different application scenarios and possessing high practicality and usability.

### CROSS-REFERENCE TO RELATED APPLICATIONS

This application claims priority to Chinese Patent Application No. 201810264884.X filed on Mar. 28, 2019, the content of which is incorporated herein by reference.

### TECHNICAL FIELD

The present application relates to the technical field of smart devices, and more particularly to a method for configuring a wireless sound box, a wireless sound box, a terminal device, and a computer readable storage medium.

### TECHNICAL FIELD

With the gradual wide application of speech technology, a smart sound box with speech interaction function, such as an smart sound box based on wireless connection (referred to as wireless sound box), has been widely popularized, and in addition to realizing speech interaction, the improvement in the sound quality of speech play is also an important direction to be developed. However, the inventors found in their study that while improving the sound quality of the wireless sound box, the speech recognition accuracy of the wireless sound box is often adversely affected, for example, at the same time of improving the sound quality of the wireless sound box and enhancing the low frequency band, the nonlinear output of the audio may be increased, the vibration of the body of the sound box would be easily caused, and the generated harmonics would affect the speech frequency band, resulting in a low accuracy of speech recognition.

### SUMMARY

In view of the above, embodiments of the present application provides a method for configuring a wireless sound box, a wireless sound box, a terminal device, and a computer readable storage medium, in order to solve the problem that the existing wireless sound box has relatively low accuracy of speech recognition after improvement of the sound quality thereof.

A first aspect of embodiments of the present application provides a method for configuring a wireless sound box, which comprises:

acquiring information of a wakeup mode of a wireless sound box, where the wakeup mode comprises: a speech wakeup mode and a non-speech wakeup mode; and

configuring an equalizer parameter of the wireless sound box according to the information of the wakeup mode, where said configuring an equalizer parameter of the wireless sound box according to the information of the wakeup mode comprises: configuring, under the speech wakeup mode, the equalizer parameter to be a first mode parameter for regulating a nonlinear distortion, and configuring, under the non-speech wakeup mode, the equalizer parameter into a second mode parameter for regulating an output sound effect.

A second aspect of embodiments of the present application provides a wireless sound box, which comprises:

an acquisition module, configured for acquiring information of a wakeup mode of a wireless sound box, where the wakeup mode comprises: a speech wakeup mode and a non-speech wakeup mode;

a configuration module, configured for configuring an equalizer parameter of the wireless sound box according to the information of the wakeup mode, where said configuring an equalizer parameter of the wireless sound box according to the information of the wakeup mode comprises: configuring, under the speech wakeup mode, the equalizer parameter to be a first mode parameter for regulating a nonlinear distortion, and configuring, under the non-speech wakeup mode, the equalizer parameter into a second mode parameter for regulating an output sound effect.

A third aspect of embodiments of the present application provides a terminal device, which comprises: a processor, a memory, and a computer program stored in the memory and executable by the processor. The processor is configured to implement steps in the above method when executing the computer program.

A fourth aspect of embodiments of the present application provides a computer readable storage medium, stored with a computer program, where steps in the above method are implemented when the computer program is executed.

Embodiments of the present application, when compared with the prior art, has the following beneficial effects: in embodiments of the present application, the information of the wakeup mode of the wireless sound box is acquired, with the wakeup mode comprising the speech wakeup mode and the non-speech wakeup mode; and the equalizer parameter of the wireless sound box is configured according to the information of the wakeup mode, with said configuring an equalizer parameter of the wireless sound box according to the information of the wakeup mode comprising configuring, under the speech wakeup mode, the equalizer parameter to be the first mode parameter for regulating the nonlinear distortion, and configuring, under the non-speech wakeup mode, the equalizer parameter to be the second mode parameter for regulating the output sound effect. In embodiments of the present application, by configuring different equalizer parameters according to different wakeup modes of the wireless sound box, the accuracy of speech recognition can be improved while improving the sound quality of the wireless sound box, thereby being adapted to the needs of different application scenarios, and possessing relatively high practicality and usability.

### BRIEF DESCRIPTION OF THE DRAWINGS

For the purpose of describing the technical solutions in the embodiments of the present application more clearly, the accompanying drawings required for describing the embodiments or the prior techniques will be briefly introduced below. It is apparent that the accompanying drawings in the following description are merely some embodiments of the present application. Those skilled in the art may obtain other drawings according to the accompanying drawings without creative efforts.

FIG. 1 is a schematic flowchart of an implementation of a method for configuring a wireless sound box provided by a first embodiment of the present application;

FIG. 2 is a schematic flowchart of an implementation of a method for configuring a wireless sound box provided by a second embodiment of the present application;

FIG. 3 is a schematic diagram of a wireless sound box provided by a third embodiment of the present application; and

FIG. 4 is a schematic diagram of a terminal device provided by a fourth embodiment of the present application.

### DETAILED DESCRIPTION OF THE EMBODIMENTS

In the following description, for the purpose of explanation rather than limitation, specific details are set forth such as particular system architectures, techniques, etc. in order to provide a thorough understanding of the embodiments of the present application. However, it will be apparent to those skilled in the art that the present application may be implemented in other embodiments that are not particularly subject to these specific details. In other instances, detailed descriptions of well-known systems, devices, circuits, and methods are omitted so as not to obscure the description of the present application with unnecessary detail.

It will be understood that the term “comprising”/“including”, when used in this specification and the appended claims, represents the presence of stated features, integers, steps, operations, elements, and/or components, but does not preclude the presence or addition of one or more other features, integers, steps, operations, elements, components, and/or groups thereof.

It is also to be understood that the terminology used herein in the specification of the present application is for the purpose of merely describing particular embodiments and is not intended to limit the present application. As used in the specification of the present application and the appended claims, the singular forms such as “a”, “an” and “the” are intended to include the plural forms unless the context clearly represents otherwise.

It is further to be understood that the term “and/or” as used in the specification of the present application and appended claims refers to any and all possible combinations of one or more of the associated listed items, and includes these combinations.

As used in this specification and the appended claims, the term “if” may be interpreted as “when” or “once” or “in response to determining” or “in response to detecting” from the context. Similarly, the phrase “if determining” or “if detecting [the described condition or event]” may be interpreted as meaning “once determining” or “in response to determining” or “once detecting [the described condition or event]” or “in response to detecting [the described condition or event]” from the context.

For the purpose of describing the technical solutions described in the present application, the description will refer to the specific embodiments below.

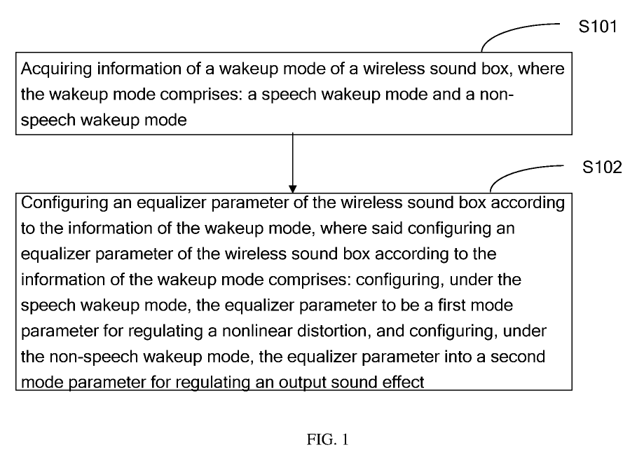

FIG. 1 is a schematic flowchart of an implementation of a method for configuring a wireless sound box provided by a first embodiment of the present application. The method illustrated in FIG. 1 may comprise the following steps:

Step S101, acquiring information of a wakeup mode of a wireless sound box, where the wakeup mode comprises: a speech wakeup mode and a non-speech wakeup mode;

In this embodiment, the wireless sound box may be a sound box adopting wireless connection to realize the signal transmission. The wireless sound box may comprise a Bluetooth wireless sound box, a Wi-Fi wireless sound box, an FM the wireless sound box, etc.

Optionally, the speech wakeup mode of the first embodiment of the present application may be collecting a speech signal and detecting whether the speech signal contains a speech wakeup information, if the speech wakeup information is contained, the wireless sound box is waken up.

Optionally, the non-speech wakeup mode of the first embodiment of the present application may comprise: a mode where wakeup is triggered by a button, and a mode where a wakeup function is turned off, of which, the mode where wakeup is triggered by the button may comprise collecting a button signal and detecting whether the button signal contains a preset button wakeup information, if the button signal contains the preset button wakeup information, the wireless sound box is waken up. Exemplarily, under the mode where the wakeup function is turned off, the wireless sound box may be used to display an audio, such as music.

Step S102, configuring an equalizer parameter of the wireless sound box according to the information of the wakeup mode, where said configuring an equalizer parameter of the wireless sound box according to the information of the wakeup mode comprises: configuring, under the speech wakeup mode, the equalizer parameter to be a first mode parameter for regulating a nonlinear distortion, and configuring, under the non-speech wakeup mode, the equalizer parameter into a second mode parameter for regulating an output sound effect.

In the first embodiment of the present application, the equalizer is a module configured for separately regulating an amplification of electrical signals of various frequency components in the wireless sound box, and compensating the defects of the speakers and the sound field and compensating and modifying various sound sources, etc. by regulating the electrical signals of different frequencies. In the first embodiment of the present application, the nonlinear distortion may be a nonlinear distortion produced by an output audio relative to an original audio. The nonlinear distortion may comprise a harmonic distortion, a clipping distortion, an intermodulation distortion, etc. When an original speech signal passes through an amplifier, in addition to an amplified input component, an output signal further includes a two-fold, three-fold, four-fold, or even much higher frequency components, which are called harmonic. While harmonic distortion refers to distortion caused by harmonic, which can be expressed by a ratio of the root mean square (rms) value of a target harmonic (second-order, third-order, etc.) to the rms value of an original frequency signal.

Optionally, in the first embodiment of the present application, the operation of configuring, under the speech wakeup mode, the equalizer parameter to be the first mode parameter for regulating the nonlinear distortion may comprise regulating a gain of a first preset frequency to a first predetermined value and/or lowering a low frequency output power to a second predetermined value under the speech wakeup mode, where the first preset frequency comprises at least one frequency band and/or at least one frequency, and the first predetermined value comprises a set of predetermined gain multiples corresponding to various frequency bands and/or various frequencies, respectively.

Exemplarily, the first preset frequency may be a continuous frequency band, for example, it may be a frequency band other than a low frequency, such as a frequency band above 150 Hz, in such case, the first predetermined value is a predetermined value of a gain multiple corresponding to the continuous frequency band. The first preset frequency band may also be a plurality of segmented frequency bands and/or single frequencies or a set of the plurality of segmented frequency bands and the single frequencies, in such case, the first predetermined value may be a set of predetermined gain multiples corresponding to the plurality of segmented frequency bands and/or single frequencies, respectively. By setting the gain values corresponding to different frequencies or frequency bands respectively, it is possible to regulate the gain of the frequency and the frequency band which are prone to nonlinear distortion, thereby reducing the nonlinear distortion. In addition, exemplarily, for a sound box equipped with a passive basin or an active woofer, the nonlinear output of the sound box can be reduced by lowering the low frequency output power to the second predetermined value, thereby alleviating vibration of the body of the wireless sound box caused by the relatively high low-frequency component, thereby reducing the interference of the speech signal and improving the recognition rate of the speech.

Optionally, in the first embodiment of the present application, the operation of configuring, under the non-speech wakeup mode, the equalizer parameter to be the second mode parameter for regulating the output sound effect may comprise regulating gains of various frequency signals to predetermined standard values and/or regulating output powers of the various frequency signals to rated output frequencies under the non-speech wakeup mode.

The standard values corresponding to the various frequency signals may be the same or different, the predetermined standard values may be a set of standard values corresponding to the various single frequency signals. By regulating the gains of the various frequency signals to the predetermined standard values and/or regulating the output powers of the various frequency signals to the rated output frequencies, the defects of the sound field of the speaker can be compensated by regulating the various different frequency signals, thereby realizing the enhancement and modification of various sound source and other particular purposes.

In the first embodiment of the present application, the information of the wakeup mode of the wireless sound box is acquired, with the wakeup mode comprising the speech wakeup mode and the non-speech wakeup mode; and the equalizer parameter of the wireless sound box is configured according to the information of the wakeup mode, with said configuring an equalizer parameter of the wireless sound box according to the information of the wakeup mode comprising configuring, under the speech wakeup mode, the equalizer parameter to be the first mode parameter for regulating the nonlinear distortion, and configuring, under the non-speech wakeup mode, the equalizer parameter to be the second mode parameter for regulating the output sound effect. In the first embodiment of the present application, by configuring different equalizer parameters according to different wakeup modes of the wireless sound box, the accuracy of speech recognition can be improved while improving the sound quality of the wireless sound box, thereby being adapted to the needs of different application scenarios, and possessing relatively high practicality and usability.

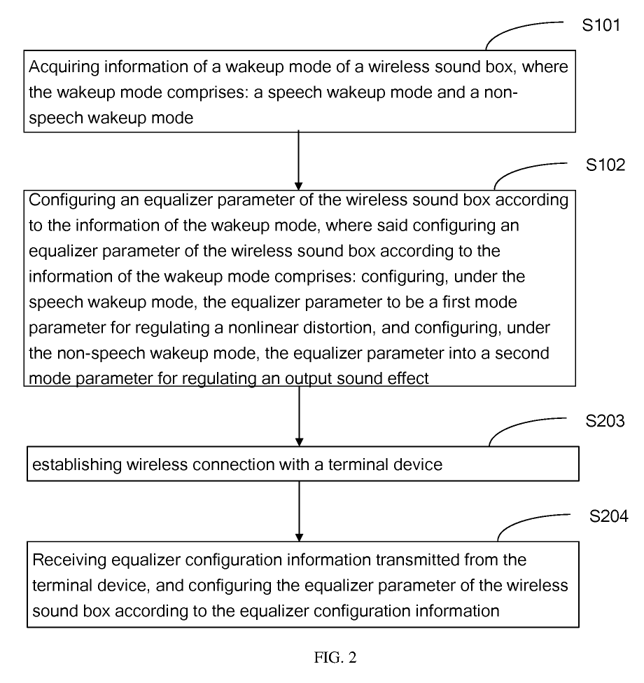

FIG. 2 is a schematic flowchart of an implementation of a method for configuring a wireless sound box provided by a second embodiment of the present application. The method illustrated in FIG. 2 may comprise the following steps:

Step S201, acquiring information of a wakeup mode of a wireless sound box, where the wakeup mode comprises: a speech wakeup mode and a non-speech wakeup mode;

Step S202, configuring an equalizer parameter of the wireless sound box according to the information of the wakeup mode, where said configuring an equalizer parameter of the wireless sound box according to the information of the wakeup mode comprises: configuring, under the speech wakeup mode, the equalizer parameter to be a first mode parameter for regulating a nonlinear distortion, and configuring, under the non-speech wakeup mode, the equalizer parameter into a second mode parameter for regulating an output sound effect.

The steps S201 and S202 in this embodiment are the same as steps S101 and S102.

Descriptions of steps S101 and S102 can be referred for details, thus would not be described herein again

Step S203, establishing wireless connection with a terminal device.

In this embodiment of the present application, the wireless connection may be a Bluetooth connection, a Wi-Fi connection, etc.

Step S204, receiving equalizer configuration information transmitted from the terminal device, and configuring the equalizer parameter of the wireless sound box according to the equalizer configuration information.

Exemplarily, in the second embodiment of the present application, after the establishment of the wireless connection between the wireless sound box and the terminal device, the wireless sound box is remotely set by the terminal device via software like APP. Exemplarily, the equalizer configuration information may comprise information of specific parameter configuration of the equalizer, and the specific parameters of the equalizer of the wireless sound box may be remotely set by the terminal device. The equalizer configuration information may also comprise information of mode configuration of the equalizer, and the pre-configured mode can be selected by the terminal device, such that the equalizer parameters can be configured by the wireless sound box according to the specific configuration parameters of such mode.

Optionally, the equalizer configuration information transmitted from the terminal device may comprise: automatically configured mode information, equalizer information configured according to the first mode parameter, or equalizer information configured according to the second mode parameter. The first mode parameter and the second mode parameter may be pre-configured by the wireless sound box.

Exemplarily, the automatically configured mode information may be information configured according to the setting of the wireless sound box.

Implementation of the second embodiment are explained taken a specific implementation mode as an example.

Exemplarily, the wireless sound box is a Bluetooth sound box, the Bluetooth sound box establishes a serial port profile connection or a Bluetooth low energy connection with the terminal device. A use mode is selected by the control software in the terminal device via a button for mode selection and then displayed, and the use mode can be switched among three modes, which are as follows: automatic mode, where when the automatic mode is selected, the automatically configured mode information is transmitted from the terminal device to the Bluetooth sound box; a high wakeup rate mode, where when the high wakeup rate mode is selected, the equalizer information configured according to the first mode parameter pre-configured by the Bluetooth sound box is transmitted from the terminal device to the Bluetooth sound box; and a high quality mode, where when the high quality mode is selected, the equalizer information configured according to the second mode parameter pre-configured by the Bluetooth sound box is transmitted from the terminal device to the Bluetooth sound box.

In the second embodiment of the present application, the information of the wakeup mode of the wireless sound box is acquired, with the wakeup mode comprising the speech wakeup mode and the non-speech wakeup mode; the equalizer parameter of the wireless sound box is configured according to the information of the wakeup mode, with said configuring an equalizer parameter of the wireless sound box according to the information of the wakeup mode comprising configuring, under the speech wakeup mode, the equalizer parameter to be the first mode parameter for regulating the nonlinear distortion, and configuring, under the non-speech wakeup mode, the equalizer parameter to be the second mode parameter for regulating the output sound effect; the wireless connection is established between the terminal device and the wireless wound box; and the equalizer configuration information transmitted from the terminal device is received by the wireless wound box, the equalizer parameter of the wireless sound box is configured according to the equalizer configuration information. In the second embodiment of the present application, by configuring different equalizer parameters according to different wakeup modes of the wireless sound box, the accuracy of speech recognition can be improved while improving the sound quality of the wireless sound box, moreover, the equalizer parameters of the wireless sound box can be configured by the terminal device to achieve the remote control, thereby being adapted to the needs of different application scenarios, and possessing relatively high practicality and usability.

It should be understood the serial number of each step in the above embodiments does not mean the sequence of execution. The sequence of execution of each process should be determined by its function and inherent logic, and should not constitute any limitation on the implementation process of the embodiments of the present application.

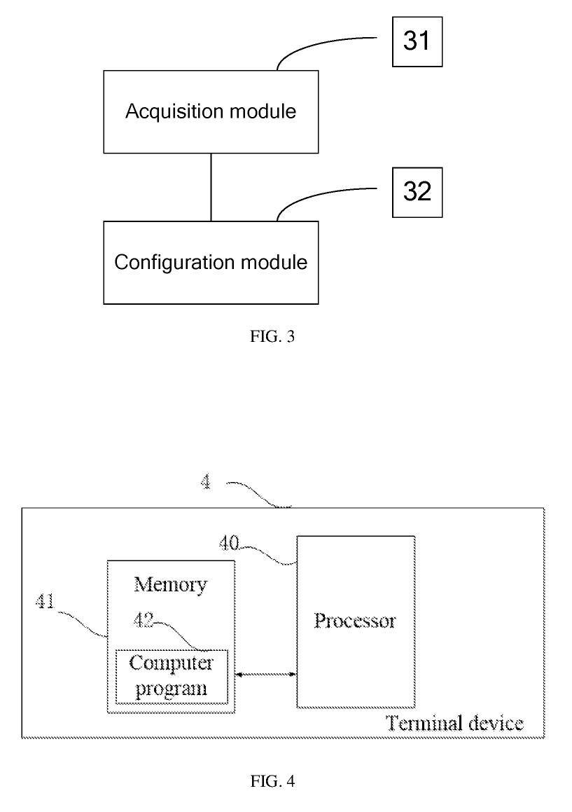

FIG. 3 is a schematic diagram of a wireless sound box provided by a third embodiment of the present application. For convenience of description, only parts related to the embodiments of the present application are shown.

The wireless sound box comprises:

an acquisition module 31, configured for acquiring information of a wakeup mode of a wireless sound box, where the wakeup mode comprises: a speech wakeup mode and a non-speech wakeup mode;

a configuration module 32, configured for configuring an equalizer parameter of the wireless sound box according to the information of the wakeup mode, where said configuring an equalizer parameter of the wireless sound box according to the information of the wakeup mode comprises: configuring, under the speech wakeup mode, the equalizer parameter to be a first mode parameter for regulating a nonlinear distortion, and configuring, under the non-speech wakeup mode, the equalizer parameter into a second mode parameter for regulating an output sound effect.

Optionally, the configuration module 32 is specifically configured for regulating a gain of a first preset frequency to a first predetermined value and/or lowering a low frequency output power to a second predetermined value under the speech wakeup mode.

Optionally, the configuration module 32 is specifically configured for regulating gains of various frequency signals to predetermined standard values and/or regulating output powers of the various frequency signals to rated output frequencies under the non-speech wakeup mode.

Optionally, the wireless sound box further comprise:

a wireless module, configured for establishing wireless connection with a terminal device.

a receiver module, configured for receiving equalizer configuration information transmitted from the terminal device, and configuring the equalizer parameter of the wireless sound box according to the equalizer configuration information.

FIG. 4 is a schematic diagram of a terminal device provided by a fourth embodiment of the present application. As shown in FIG. 4, the terminal device 4 of this embodiment includes a processor 40, a memory 41, and a computer program 42 stored in the memory 41 and executable by the processor 40. The processor 40, when executing the computer program 42, implements steps in the method embodiments as described above, such as steps S101 to S102 shown in FIG. 1. Alternatively, the processor 40, when executing the computer program 42, implements the functions of each module/unit in the embodiments of the terminal device described above, such as the functions of the modules 31 to 32 shown in FIG. 3.

Exemplarily, the computer program 42 may be divided into one or more modules/units, which are stored in the memory 41 and executed by the processor 40 to complete the present application. The one or more modules/units may be a series of computer program instruction segments capable of completing a particular function, and the instruction segments are used to describe the executing process of the computer program 42 in the terminal device 4. For example, the computer program 42 may be divided into an acquisition module and a configuration module, and specific functions of these modules are as follows:

an acquisition module, configured for acquiring information of a wakeup mode of a wireless sound box, where the wakeup mode comprises: a speech wakeup mode and a non-speech wakeup mode;

a configuration module, configured for configuring an equalizer parameter of the wireless sound box according to the information of the wakeup mode, where said configuring an equalizer parameter of the wireless sound box according to the information of the wakeup mode comprises: configuring, under the speech wakeup mode, the equalizer parameter to be a first mode parameter for regulating a nonlinear distortion, and configuring, under the non-speech wakeup mode, the equalizer parameter into a second mode parameter for regulating an output sound effect.

The terminal device 4 may be a computing device such as a desktop computer, a notebook, a palmtop computer, and a cloud server. The terminal device may include, but is not limited to, a processor 40 and a memory 41. It will be understood by those skilled in the art that FIG. 4 is only an example of the terminal device 4 rather than limiting the terminal device 4, it may include more or less components than those illustrated, or combine some components, or different components. For example, the terminal device may further include an input/output device, a network access device, a bus, and the like.

The processor 40 may be a Central Processing Unit (CPU), a general purpose processor, a Digital Signal Processor (DSP), an Application Specific Integrated Circuit (ASIC), a Field-Programmable Gate Array (FPGA), a programmable logic device, a discrete gate or a transistor logic device, a discrete hardware component, etc. The general purpose processor may be a microprocessor or the processor may also be any conventional processor, etc.

The memory 41 may be an internal storage unit of the terminal device 4, such as a hard disk or a memory of the terminal device 4. The memory 41 may also be an external storage device of the terminal device 4, such as a plug-in hard disk, a Smart Media Card (SMC), a Secure Digital (SD) card, a flash card, etc. provided on the terminal device 4. Further, the memory 41 may further include both an internal storage unit and an external storage device of the terminal device 4. The memory 41 is used to store the computer program and other programs and data required by the terminal device. The memory 41 may also be used to temporarily store data that has been or will be output.

Those skilled in the art may clearly understand that, for the convenience and simplicity of description, only the division of the above functional modules is used as an example. In practical applications, the above function allocation may be accomplished by different functional modules as needed. That is to say, the internal structure of the apparatus is divided into different functional modules to accomplish all or part of the functions described above. Each of the functional modules in some embodiments may be integrated in one processing module, or each of the modules may exist in a single physical manner, or two or more modules may be integrated in one module. The above integrated module may be implemented in the form of hardware, or may be implemented in the form of a software functional module. In addition, the specific names of the various functional modules are merely for the convenience of distinguishing each other and are not intended to limit the protection scope of the present application. For the specific working process of the module in the foregoing device, reference may be made to the corresponding process in the foregoing method embodiment, which will not be described herein again.

In the above embodiments, the description of different embodiments has different focus, and the parts that are not described or recorded in some embodiments may refer to the related descriptions in other embodiments.

It may be appreciated by those skilled in the art that the units and algorithm steps of each example described in combination with the embodiments disclosed herein are capable of being implemented by electronic hardware or a combination of computer software and electronic hardware. Whether these functions are implemented by hardware or software depends on the specific application and design constraints of the technical solutions. Those skilled in the art may use different methods to implement the described functions for each particular application, but such implementation should not be considered to go beyond the scope of the present application.

In the embodiments provided by the present application, it should be understood that the disclosed terminal device and method may be implemented in other manners. For example, the terminal device embodiments described above is merely exemplary. For example, the division of the modules or units is merely logical function division, and there may be other division manners in actual implementation. For example, multiple units or components may be combined or integrated into another system, or some of the features may be ignored or not implemented. In addition, the mutual coupling or direct coupling or communication connection shown or discussed may be indirect coupling or communication connection through some interfaces, devices or units, and may be in electrical, mechanical or other forms.

The units described as separate components may or may not be physically separated. The components displayed as units may or may not be physical units. That is to say, the components may be located in one place or may also be distributed to multiple network units. Some or all of the units may be selected according to actual needs to achieve the objectives of the solution in this embodiment.

In addition, each of the function units in different embodiments of the present application may be integrated in one processing unit, or each of the units may exist in a single physical manner, or two or more units may be integrated in one unit. The above integrated module may be implemented in the form of hardware or may be implemented in the form of a software function unit.

If implemented in the form of a software function unit and when sold or used as an independent product, the integrated module/unit may be stored in a computer readable storage medium. Based on this understanding, all or a part of the processes of the present application for implementing the above exemplary method may also be implemented by instructing relevant hardware through a computer program. The computer program may be stored in a computer readable storage medium. The computer program, when being executed by the processor, may implement steps in each of the method embodiments described above. Herein, the computer program includes a computer program code, which may be in the form of a source code, in the form of an object code, in the form of an executable file or in some intermediate form, etc. The computer readable medium may include any entity or device capable of carrying the computer program code, a recording medium, a USB flash drive, a removable disk, a magnetic disk, an optical disk, a computer memory, a Read-Only Memory (ROM), a Random Access Memory (RAM), electrical carrier signals, telecommunications signals, a software distribution medium, etc. It should be noted that the content contained in the computer readable medium may be appropriately increased or decreased according to the requirements of legislation and patent practice in the jurisdiction. For example, in some jurisdictions, according to legislation and patent practice, a computer readable medium excludes electric carrier signals and telecommunication signals.

The foregoing embodiments are merely intended for describing the technical solutions of the present application rather than limiting the present application. Although the present application is described in detail with reference to the foregoing embodiments, it should be understood by those skilled in the art that the technical solutions recorded in each of the foregoing embodiments may still be modified or some of the technical features may be replaced equivalently. These modifications or replacements do not make the essence of the corresponding technical solutions depart from the spirit and scope of the technical solutions of each of the embodiments of the present application, and should be included within the protection scope of the present application.

What is claimed is:

1. A method for configuring a wireless sound box, comprising:
acquiring information of a wakeup mode of a wireless sound box, wherein the wakeup mode comprises: a speech wakeup mode and a non-speech wakeup mode; and
configuring an equalizer parameter of the wireless sound box according to the information of the wakeup mode, wherein said configuring an equalizer parameter of the wireless sound box according to the information of the wakeup mode comprises: configuring, under the speech wakeup mode, the equalizer parameter to be a first mode parameter for regulating a nonlinear distortion, and configuring, under the non-speech wakeup mode, the equalizer parameter into a second mode parameter for regulating an output sound effect.

2. The method of claim 1, wherein the non-speech wakeup mode comprises: a mode where wakeup is triggered by a button, and a mode where a wakeup function is turned off.

3. The method of claim 1, wherein the operation of configuring, under the speech wakeup mode, the equalizer parameter to be the first mode parameter for regulating the nonlinear distortion comprises:
regulating a gain of a first preset frequency to a first predetermined value and/or lowering a low frequency output power to a second predetermined value under the speech wakeup mode, wherein the first preset frequency comprises at least one frequency band and/or at least one frequency, and the first predetermined value comprises a set of predetermined gain multiples corresponding to various frequency bands and/or various frequencies, respectively.

4. The method of claim 1, wherein the operation of configuring, under the non-speech wakeup mode, the equalizer parameter to be the second mode parameter for regulating the output sound effect comprises:
regulating gains of various frequency signals to predetermined standard values and/or regulating output powers of the various frequency signals to rated output frequencies under the non-speech wakeup mode.

5. The method of claim 1, further comprising:
establishing wireless connection with a terminal device; and
receiving equalizer configuration information transmitted from the terminal device, and configuring the equalizer parameter of the wireless sound box according to the equalizer configuration information.

6. The method of claim 5, wherein the equalizer configuration information transmitted from the terminal device comprises: automatically configured mode information, equalizer information configured according to the first mode parameter, or equalizer information configured according to the second mode parameter.

7. The method of claim 1, wherein the speech wakeup mode comprises collecting a speech signal and detecting whether the speech signal contains a speech wakeup information; and
waking up the wireless sound box if the speech wakeup information is contained.

8. A wireless sound box, comprising:
an acquisition module, configured for acquiring information of a wakeup mode of a wireless sound box, wherein the wakeup mode comprises: a speech wakeup mode and a non-speech wakeup mode;
a configuration module, configured for configuring an equalizer parameter of the wireless sound box according to the information of the wakeup mode, wherein said configuring an equalizer parameter of the wireless sound box according to the information of the wakeup mode comprises: configuring, under the speech wakeup mode, the equalizer parameter to be a first mode parameter for regulating a nonlinear distortion, and configuring, under the non-speech wakeup mode, the equalizer parameter into a second mode parameter for regulating an output sound effect.

9. The wireless sound box of claim 8, wherein the non-speech wakeup mode comprises: a mode where wakeup is triggered by a button, and a mode where a wakeup function is turned off.

10. The wireless sound box of claim 8, wherein the configuration module is configure for:
regulating a gain of a first preset frequency to a first predetermined value and/or lowering a low frequency output power to a second predetermined value under the speech wakeup mode, wherein the first preset frequency comprises at least one frequency band and/or at least one frequency, and the first predetermined value comprises a set of predetermined gain multiples corresponding to various frequency bands and/or various frequencies, respectively.

11. The wireless sound box of claim 8, wherein the configuration module is configure for:
regulating gains of various frequency signals to predetermined standard values and/or regulating output powers of the various frequency signals to rated output frequencies under the non-speech wakeup mode.

12. The wireless sound box of claim 8, further comprising:
a wireless module, configured for establishing wireless connection with a terminal device,
a receiver module, configured for receiving equalizer configuration information transmitted from the terminal device, and configuring the equalizer parameter of the wireless sound box according to the equalizer configuration information.

13. The wireless sound box of claim 12, wherein the equalizer configuration information transmitted from the terminal device comprises: automatically configured mode information, equalizer information configured according to the first mode parameter, or equalizer information configured according to the second mode parameter.

14. The wireless sound box of claim 8, wherein the speech wakeup mode comprises collecting a speech signal and detecting whether the speech signal contains a speech wakeup information; and waking up the wireless sound box if the speech wakeup information is contained.

15. A terminal device, comprising: a processor, a memory, and a computer program stored in the memory and executable by the processor, wherein the processor is configured to implement steps of the method according to claim 1 when executing the computer program.

16. The terminal device of claim 15, wherein the non-speech wakeup mode comprises: a mode where wakeup is triggered by a button, and a mode where a wakeup function is turned off.

17. The terminal device of claim 15, wherein the operation of configuring, under the speech wakeup mode, the equalizer parameter to be the first mode parameter for regulating the nonlinear distortion comprises:
regulating a gain of a first preset frequency to a first predetermined value and/or lowering a low frequency output power to a second predetermined value under the speech wakeup mode, wherein the first preset frequency comprises at least one frequency band and/or at least one frequency, and the first predetermined value comprises a set of predetermined gain multiples corresponding to various frequency bands and/or various frequencies, respectively.

18. The terminal device of claim 15, wherein the operation of configuring, under the non-speech wakeup mode, the equalizer parameter to be the second mode parameter for regulating the output sound effect comprises:
regulating gains of various frequency signals to predetermined standard values and/or regulating output powers of the various frequency signals to rated output frequencies under the non-speech wakeup mode.

19. The terminal device of claim 15, the method further comprises:
establishing wireless connection with the terminal device; and
receiving equalizer configuration information transmitted from the terminal device, and configuring the equalizer parameter of the wireless sound box according to the equalizer configuration information.

20. The terminal device of claim 19, wherein the equalizer configuration information transmitted from the terminal device comprises: automatically configured mode information, equalizer information configured according to the first mode parameter, or equalizer information configured according to the second mode parameter.
